(19) United States
(12) Patent Application Publication
(10) Pub. No.: US 2025/0356795 A1
(43) Pub. Date: Nov. 20, 2025

(54) DISPLAY DEVICE AND ELECTRONIC DEVICE INCLUDING DISPLAY DEVICE

(71) Applicant: SAMSUNG DISPLAY CO., LTD., YONGIN-SI (KR)

(72) Inventors: Chol Ho KIM, YONGIN-SI (KR); Won Jun LEE, YONGIN-SI (KR)

(21) Appl. No.: 18/965,565

(22) Filed: Dec. 2, 2024

(30) Foreign Application Priority Data
May 16, 2024 (KR) 10-2024-0063893

(51) Int. Cl. G09G 3/32; G09G 3/3266; G09G 3/3275

(52) U.S. Cl. CPC G09G 3/32; G09G 3/3266; G09G 3/3275; G09G 2310/0267; G09G 2310/0275; G09G 2310/08; G09G 2320/0247; G09G 2330/021

(57) ABSTRACT

A display device includes a pixel including a light emitting element and a first transistor connected between a first node and a second node and generating a driving current. The pixel is connected to a first scan line, a second scan line, a third scan line, a fourth scan line, a fifth scan line, an emission control line, and a data line. The display device further includes an emission driver that supplies an emission control signal to the emission control line, a scan driver that supplies first to fifth scan signals respectively to the first to fifth scan lines in a period in which the emission control signal is supplied, and a data driver that supplies a data signal to the data line. The first scan signal controls a timing at which the second node and a first electrode of the light emitting element are connected to each other.

### CROSS-REFERENCE TO RELATED APPLICATIONS

This application claims priority under 35 U.S.C. § 119 to Korean Patent Application No. 10-2024-0063893 filed on May 16, 2024, the disclosure of which is incorporated by reference herein in its entirety.

### TECHNICAL FIELD

Embodiments of the present disclosure relate to a display device and an electronic device including the display device.

### Discussion of Related Art

Enhancing the driving efficiency of a display device can be achieved by reducing power consumption. For example, power consumption can be reduced by lowering the driving frequency (or data write frequency). Additionally, the display device may operate at different frame frequencies (or driving frequencies) to display images under various conditions.

### SUMMARY

Embodiments of the present application provide a display device that supplies a data voltage corresponding to each of a plurality of sub-pixels.

According to an embodiment of the present application, a display device includes a pixel including a light emitting element and a first transistor connected between a first node and a second node. The first transistor is configured to generate a driving current. The pixel is connected to a first scan line, a second scan line, a third scan line, a fourth scan line, a fifth scan line, an emission control line, and a data line. The display device further includes an emission driver configured to supply an emission control signal to the emission control line, a scan driver configured to supply first to fifth scan signals respectively to the first to fifth scan lines in a period in which the emission control signal is supplied, and a data driver configured to supply a data signal to the data line. The first scan signal controls a timing at which the second node and a first electrode of the light emitting element are connected to each other.

In an embodiment, the pixel further includes a second transistor connected between the data line and the first node, which is turned on in response to the second scan signal, a third transistor connected between the second node and a third node to which a gate electrode of the first transistor is connected, which is turned on in response to the third scan signal, a fourth transistor connected between the first node and a first power line that provides a voltage of a first power source, which is turned on in response to the fourth scan signal, a fifth transistor connected between a second power line that provides a driving power source and the first node, which is turned off in response to the emission control signal, a sixth transistor connected between the second node and the first electrode of the light emitting element, which is turned off in response to the emission control signal supplied to the emission control line, and a seventh transistor connected between the second node and the first electrode of the light emitting element, which is turned on in response to the first scan signal.

In an embodiment, after the scan driver supplies the fourth scan signal to the fourth scan line, the scan driver supplies the first scan signal to the first scan line.

In an embodiment, the pixel further includes an eighth transistor connected between the third node and a third power line that provides a voltage of a second power source, which is turned on in response to the fifth scan signal.

In an embodiment, the pixel further includes a ninth transistor connected between the first electrode of the light emitting element and a fourth power line that provides a voltage of a third power source, which is turned on in response to the fourth scan signal.

In an embodiment, one frame period includes a plurality of non-emission periods divided by the emission control signal, the scan driver supplies the fourth scan signal in the non-emission periods, and the scan driver supplies the first scan signal, the second scan signal, the third scan signal, and the fifth scan signal in only a first non-emission period among the non-emission periods.

In an embodiment, the first non-emission period includes a first period and a second period subsequent to the first period, and the scan driver is further configured to supply the fourth scan signal to the fourth scan line in the first period and supply the first scan signal to the first scan line in the second period.

In an embodiment, the first non-emission period further includes a third period subsequent to the second period, a fourth period subsequent to the third period, and a fifth period subsequent to the fourth period, and the scan driver is further configured to supply the fifth scan signal to the fifth scan line in the third period, supply the third scan signal to the third scan line in the fourth period, and supply the second scan signal to the second scan line and supply the third scan signal to the third scan line in the fifth period. A time at which the fifth period is ended is earlier than a time at which the first period is started.

According to an embodiment of the present disclosure, a display device includes a pixel including a light emitting element and a first transistor connected between a first node and a second node. The first transistor is configured to generate a driving current. The pixel is connected to a first scan line, a second scan line, a third scan line, a fourth scan line, an emission control line, and a data line. The display device further includes an emission driver configured to supply an emission control signal to the emission control line, a scan driver configured to supply first to fourth scan signals respectively to the first to fourth scan lines in a period in which the emission control signal is supplied, and a data driver configured to supply a data signal to the data line. The first scan signal controls a timing at which the second node and a first electrode of the light emitting element are connected to each other.

In an embodiment, the pixel further includes a second transistor connected between the data line and the first node, which is turned on in response to the second scan signal, a third transistor connected between the second node and a third node to which a gate electrode of the first transistor is connected, which is turned on in response to the third scan signal, a fourth transistor connected between the first node and a first power line that provides a voltage of a first power source, which is turned on in response to the first scan signal, a fifth transistor connected between a second power line that provides a driving power source and the first node, which is turned off in response to the emission control signal, a sixth transistor connected between the second node and the first electrode of the light emitting element, which is turned off in response to the emission control signal supplied to the emission control line, and a seventh transistor connected between the second node and the first electrode of the light emitting element, which includes a gate electrode connected to the first node.

In an embodiment, the pixel further includes an eighth transistor connected between the first electrode of the light emitting element and a third power line that provides a voltage of a second power source, which is turned on in response to the first scan signal.

In an embodiment, the pixel further includes a capacitor connected between the first node and a gate electrode of the eighth transistor.

In an embodiment, the pixel further includes a ninth transistor connected between the third node and a fourth power line that provides a voltage of a third power source, which is turned on in response to the fourth scan signal.

In an embodiment, one frame period includes a plurality of non-emission periods divided by the emission control signal. The scan driver supplies the first scan signal in the non-emission periods, and the scan driver supplies the second scan signal, the third scan signal, and the fourth scan signal in only a first non-emission period among the non-emission periods.

In an embodiment, the pixel further includes a second transistor connected between the data line and the first node, which is turned on in response to the second scan signal, a third transistor connected between the second node and a third node connected to the gate electrode of the first transistor, which is turned on in response to the third scan signal, a fourth transistor connected between the first node and a first power line that provides a voltage of a first power source, which is turned on in response to the first scan signal, a fifth transistor connected between a second power line that provides a driving power source and the first node, which is turned off in response to the emission control signal, a sixth transistor connected between the second node and the first electrode of the light emitting element, which is turned off in response to the emission control signal, a seventh transistor connected between the first electrode of the light emitting element and a third power line that provides a voltage of a second power source, which is turned on in response to the first scan signal, and an eighth transistor connected between the second node and the first electrode of the light emitting element, which includes a gate electrode connected to a gate electrode of the seventh transistor.

In an embodiment, the pixel further includes a ninth transistor connected between the third node and a fourth power line that provides a voltage of a third power source, which is turned on in response to the fourth scan signal.

According to an embodiment of the present disclosure, a display device includes a pixel including a light emitting element and a first transistor connected between a first node and a second node. The first transistor is configured to generate a driving current. The pixel is connected to a first scan line, a second scan line, a third scan line, a fourth scan line, an emission control line, and a data line. The display device further includes an emission driver configured to supply and suspend an emission control signal to the emission control line, a scan driver configured to supply first to fourth scan signals respectively to the first to fourth scan lines in a period in which the emission control signal is supplied, and a data driver configured to supply a data signal to the data line. A voltage including a plurality of pulses is provided to a first electrode of the light emitting element before the supply of the emission control signal is suspended.

In an embodiment, the pixel further includes a second transistor connected between the data line and the first node, which is turned on in response to the first scan signal, a third transistor connected between the second node and a third node to which a gate electrode of the first transistor is connected, which is turned on in response to the second scan signal, a fourth transistor connected between the first node and a first power line that provides a voltage of a first power source, which is turned on in response to the third scan signal, a fifth transistor connected between a second power line that provides a driving power source and the first node, which is turned off in response to the emission control signal, a sixth transistor connected between the second node and the first electrode of the light emitting element, which is turned off in response to the emission control signal supplied to the emission control line, and a seventh transistor connected between the first electrode of the light emitting element and a third power line that provides a voltage of a second power source, which is turned on in response to the third scan signal.

In an embodiment, the pixel further includes an eighth transistor connected between the third node and a fourth power line that provides a voltage of a third power source, which is turned on in response to the fourth scan signal.

In an embodiment, the voltage of the second power source includes the plurality of pulses.

According to an embodiment of the present application, an electronic device includes a processor to provide input image data; and a display device to display an image based on the input image data. The display device includes a pixel including a light emitting element and a first transistor connected between a first node and a second node. The first transistor is configured to generate a driving current. The pixel is connected to a first scan line, a second scan line, a third scan line, a fourth scan line, a fifth scan line, an emission control line, and a data line. The display device further includes an emission driver configured to supply an emission control signal to the emission control line, a scan driver configured to supply first to fifth scan signals respectively to the first to fifth scan lines in a period in which the emission control signal is supplied, and a data driver configured to supply a data signal to the data line. The first scan signal controls a timing at which the second node and a first electrode of the light emitting element are connected to each other.

### BRIEF DESCRIPTION OF THE DRAWINGS

The above and other features of the present disclosure will become more apparent by describing in detail embodiments thereof with reference to the accompanying drawings.

FIG. 1 is a diagram illustrating a display device according to embodiments of the present disclosure.

FIG. 2 is a diagram illustrating an example of a scan driver included in the display device shown in FIG. 1.

FIG. 3 is a circuit diagram illustrating an example of a pixel included in the display device shown in FIG. 1.

FIG. 4 is a timing diagram illustrating an example of signals supplied to the pixel shown in FIG. 3.

FIG. 5 is a timing diagram illustrating an example of signals supplied to the pixel shown in FIG. 3 during one frame period.

FIG. 6 is a circuit diagram illustrating an example of a pixel included in the display device shown in FIG. 1.

FIG. 7 is a circuit diagram illustrating an example of a pixel included in the display device shown in FIG. 1.

FIG. 8 is a circuit diagram illustrating an example of a pixel included in the display device shown in FIG. 1.

FIG. 9 is a block diagram illustrating an electronic device in accordance with embodiments of the present disclosure.

FIG. 10 is a schematic diagram illustrating an example where the electronic device of FIG. 9 is implemented as a smartphone.

FIG. 11 is a schematic diagram illustrating an example where the electronic device of FIG. 9 is a tablet computer.

### DETAILED DESCRIPTION

Embodiments of the present disclosure will be described more fully hereinafter with reference to the accompanying drawings. Like reference numerals may refer to like elements throughout the accompanying drawings.

It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the present disclosure.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. Other words used to describe the relationships between components should be interpreted in a like fashion.

The term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art. Further, it is to be understood that while parameters may be described herein as having “about” a certain value, according to embodiments, the parameter may be exactly the certain value or approximately the certain value within a measurement error as would be understood by a person having ordinary skill in the art.

At low driving frequencies, driving current leakage in a pixel may occur, which can lead to noticeable image flicker. Additionally, changes in frame frequency or frame response speed can cause image distortion. Embodiments of the present application address these issues, as described further below.

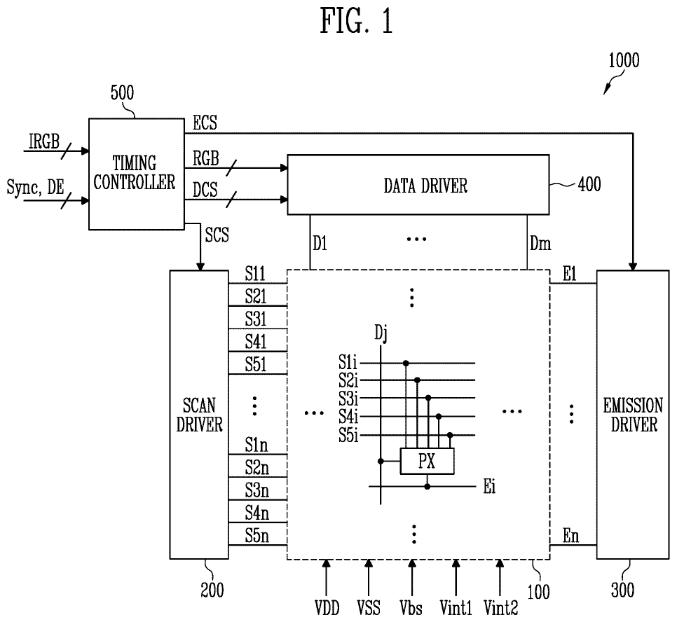

FIG. 1 is a diagram illustrating a display device according to embodiments of the present disclosure.

Referring to FIG. 1, the display device 1000 may include a pixel unit 100 (also referred to as a display panel), a scan driver 200 (also referred to as a scan driver circuit), an emission driver 300 (also referred to as an emission driver circuit), a data driver 400 (also referred to as a data driver circuit), and a timing controller 500 (also referred to as a timing controller circuit).

The display device 1000 may display an image at various frame frequencies (e.g., refresh rates, driving frequencies or screen refresh rates) according to driving conditions. A frame frequency is a frequency at which a data voltage is substantially written to a driving transistor of a pixel PX for one second. For example, the frame frequency may also be referred to as a screen scan rate or a screen refresh frequency, and may represent a frequency at which a display screen is reproduced for one second.

In an embodiment, an output frequency of the data driver 400 and/or a third scan signal supplied to a third scan line S3i to supply a data signal may be changed corresponding to the frame frequency. For example, a frame frequency for driving a moving image (e.g., a video) may be a frequency of about 60 Hz or higher (e.g., about 12 Hz). When the frame frequency is about 60 Hz, the third scan signal may be supplied sixty times per second to each horizontal line (pixel row).

In an embodiment, the display device 1000 may adjust an output frequency of the scan driver 200 and the emission driver 300 and an output frequency of the data driver 400, which corresponds thereto according to driving conditions. For example, the display device 1000 may display an image, corresponding to various frame frequencies of about 1 Hz to about 120 Hz. However, the present disclosure is not limited thereto. For example, according to embodiments, the display device 1000 may display an image at a frame frequency of about 120 Hz or higher (e.g., about 240 Hz or about 480 Hz).

The pixel unit 100 may include scan lines S11 to S1n, S21 to S2n, S31 to S3n, S41 to S4n, and S51 to S5n, emission control lines E1 to En, and data lines D1 to Dm, and include pixels PX connected to the scan lines S11 to Sln, S21 to S2n, S31 to S3n, S41 to S4n, and S51 to S5n, the emission control lines E1 to En, and the data lines D1 to Dm (where m and n are integers of 1 or more). Each of the pixels PX may include a driving transistor and a plurality of switching transistors.

The timing controller 500 may be supplied with input image data IRGB and control signals Sync and DE from a host system such as, for example, an application processor (AP), through a predetermined interface.

The timing controller 500 may generate a first control signal SCS, a second control signal ECS, and a third control signal DCS, based on the input image data IRGB, a synchronization signal Sync (e.g., a vertical synchronization signal, a horizontal synchronization, and the like), a data enable signal DE, a clock signal, and the like. The first control signal SCS may be supplied to the scan driver 200, the second control signal ECS may be supplied to the emission driver 300, and the third control signal DCS may be supplied to the data driver 400. The timing controller 500 may realign the input image data IRGB and supply the realigned input image data to the data driver 400.

The scan driver 200 may receive the first control signal SCS from the timing controller 500, and supply a first scan signal, a second scan signal, the third scan signal, a fourth scan signal, and a fifth scan signal respectively to first scan lines S11 to S1n, second scan lines S21 to S2n, third scan lines S31 to S3n, fourth scan lines S41 to S4n, and fifth scan lines S51 to S5n, based on the first control signal SCS, where i is a positive integer.

Each of the first to fifth scan signals may be set to a gate-on voltage corresponding to the type of a transistor to which the corresponding scan signal is supplied.

A transistor receiving a scan signal may be set to be in a turn-on state when the scan signal is supplied. For example, a gate-on voltage of a scan signal supplied to a P-channel metal oxide semiconductor (PMOS) transistor may have a logic low level, and a gate-on voltage of a scan signal supplied to an N-channel metal oxide semiconductor (NMOS) transistor may have a logic high level. Hereinafter, the meaning of the phrase “that a scan signal is supplied” may be understood as meaning that the scan signal is supplied at a logic level at which a transistor controlled thereby is turned on.

In an embodiment, the scan driver 200 may supply some of the first to fifth scan signals a plurality of times in a non-emission period. Accordingly, a bias state of the driving transistor included in the pixel PX may be controlled.

The emission driver 300 may supply an emission control signal to the emission control lines E1 to En, based on the second control signal ECS. For example, the emission control signal may be sequentially supplied to the emission control lines E1 to En.

The emission control signal may be set to a gate-off voltage (e.g., a high voltage). A transistor receiving the emission control signal may be turned off when the emission control signal is supplied, and be set to be in a turn-on state in other cases. Hereinafter, the meaning of the phrase “that an emission control signal is supplied” may be understood as meaning that the emission control signal is supplied at a logic level at which a transistor controlled thereby is turned off.

In FIG. 1, for convenience of description, it is illustrated that each of the scan driver 200 and the emission driver 300 is a single component. However, the present disclosure is not limited thereto. For example, according to embodiments, the scan driver 200 may include a plurality of scan drivers which respectively supply at least one of the first to fifth scan signals depending on the specific design requirements. In addition, at least a portion of the scan driver 200 and the emission driver 300 may be integrated as a single driving circuit, a single module, or the like.

The data driver 400 may receive the third control signal DCS and image data RGB from the timing controller 500. The data driver 400 may convert the image data RGB, which is in a digital form, into an analog data signal (data voltage). The data driver 400 may supply a data signal to the data lines D1 to Dm in response to the third control signal DCS. The data signal supplied to the data lines D1 to Dm may be synchronized with the third scan signal supplied to the third scan lines S31 to S3n.

In an embodiment, the display device 1000 may further include a power supply. The power supply may supply, to the pixel unit 100, a voltage of a first driving power source VDD, a voltage of a second driving voltage VSS, a voltage of a first power source Vbs (or bias power source), a voltage of a second power source Vint1 (or first initialization power source), and a voltage of a third power source Vint2 (or second initialization power source), which are used to drive the pixel PX.

The display device 1000 may operate at various frame frequencies. In the case of low frequency driving, an image failure such as flickering may occur due to current leakage in the pixel. In addition, an afterimage such as blurring, caused by, e.g., a response speed change due to a bias state change of the driving transistor, a threshold voltage shift according to a hysteresis characteristic, or the like, may occur as a result of driving at various frame frequencies.

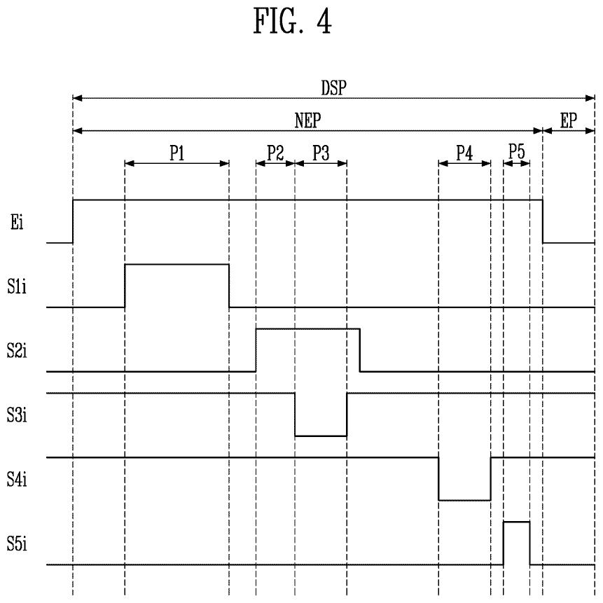

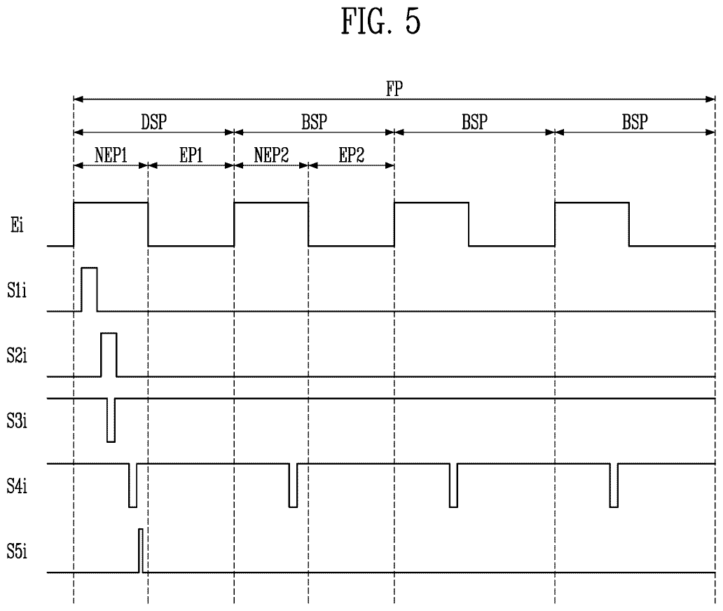

According to embodiments, one frame period of the pixel PX may include one display scan period and at least one bias scan period according to a frame frequency. As a result, image quality may be improved. An operation of the display scan period and the bias scan period will be described in detail with reference to FIGS. 4 and 5.

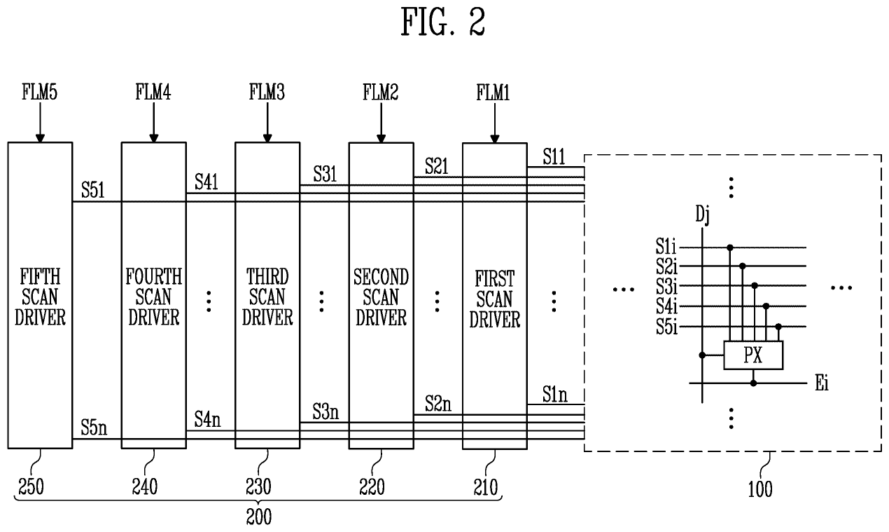

FIG. 2 is a diagram illustrating an example of the scan driver 200 included in the display device 1000 shown in FIG. 1.

Referring to FIGS. 1 and 2, the scan driver 200 may include a first scan driver 210 (also referred to as a first scan driver circuit), a second scan driver 220 (also referred to as a second scan driver circuit), a third scan driver 230 (also referred to as a third scan driver circuit), a fourth scan driver 240 (also referred to as a fourth scan driver circuit), and fifth scan driver 250 (also referred to as a fifth scan driver circuit).

The first control signal SCS may include first to fifth scan start signals FLM1 to FLM5. The first to fifth scan start signals FLM1 to FLM5 may be supplied to the first to fifth scan drivers 210, 220, 230, 240, and 250, respectively.

A width, a supply timing, and the like of each of the first to fifth scan start signals FLM1 to FLM5 may be determined according to a driving condition and a frame frequency of the pixel PX. The first to fifth scan signals may be output based on the first to fifth scan start signals FLM1 to FLM5, respectively. For example, a signal width of at least one of the first to fifth scan signals may be different from a signal width of the others of the first to fifth scan signals.

The first scan driver 210 may sequentially supply the first scan signal to the first scan lines S11 to S1n in response to the first scan start signal FLM1. The second scan driver 220 may sequentially supply the second scan signal to the second scan lines S21 to S2n in response to the second scan start signal FLM2. The third scan driver 230 may sequentially supply the third scan signal to the third scan lines S31 to S3n in response to the third scan start signal FLM3. The fourth scan driver 240 may sequentially supply the fourth scan signal to the fourth scan lines S41 to S4n in response to the fourth scan start signal FLM4. The fifth scan driver 250 may sequentially supply the fifth scan signal to the fifth scan lines S51 to S5n in response to the fifth scan start signal FLM5.

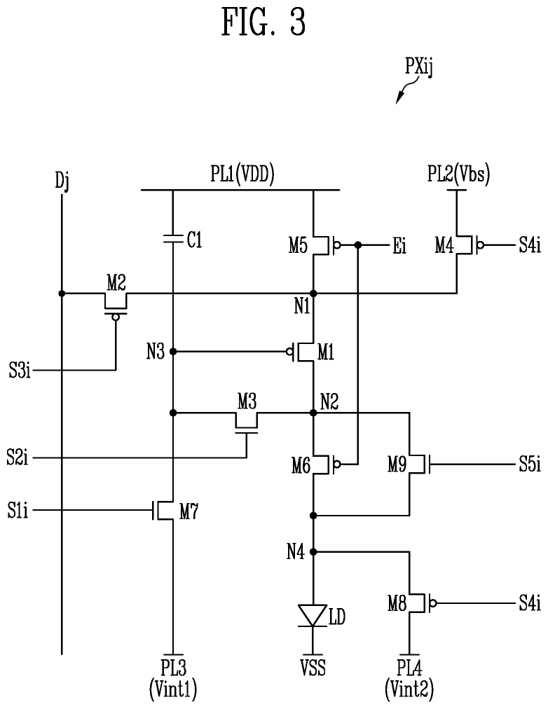

FIG. 3 is a circuit diagram illustrating an example of the pixel PX included in the display device 1000 shown in FIG. 1.

In FIG. 3, for convenience of description, a pixel PXij which is located on an ith horizontal line (or ith pixel row) and is connected to a jth data line Dj will be illustrated (i and j are positive integers).

Referring to FIGS. 1 and 3, the pixel PXij may include a light emitting element LD, first to ninth transistors M1 to M9, and a first capacitor C1.

A first electrode (anode electrode or cathode electrode) of the light emitting element LD may be connected to the sixth transistor M6, and a second electrode (cathode electrode or anode electrode) of the light emitting element LD may be connected to an electrode which provides the second driving power source VSS. The light emitting element LD may generate light with a predetermined luminance, corresponding to an amount of current supplied from the first transistor M1.

In an embodiment, the light emitting element LD may be an organic light emitting diode including an organic light emitting layer. In an embodiment, the light emitting element LD may be an inorganic light emitting element formed of an inorganic material. In an embodiment, the light emitting element LD may be a light emitting element configured with a combination of an inorganic material and an organic material. Alternatively, the light emitting element LD may have a form in which a plurality of inorganic light emitting elements are connected in parallel and/or series between the second driving power source VSS and the sixth transistor M6.

A first electrode of the first transistor M1 (or driving transistor) may be connected to a first node N1, and a second electrode of the first transistor M1 may be connected to a second node N2. A gate electrode of the first transistor M1 may be connected to a third node N3. The first transistor M1 may control an amount of current flowing from the first driving power source VDD to the second driving power source VSS via the light emitting element LD, corresponding to a voltage of the third node N3. To this end, the first driving power source VDD may be set to a voltage higher than the voltage of the second driving power source VSS.

The second transistor M2 may be connected between the jth data line Dj (hereinafter, referred to as a data line) and the first node N1. A gate electrode of the second transistor M2 may be connected to a third scan line S3i. The second transistor M2 may be turned on when the third scan signal is supplied to the third scan line S3i, to electrically connect the data line Dj and the first node N1 to each other.

The third transistor M3 may be connected between the second electrode of the first transistor M1 (e.g., the second node N2) and the third node N3. A gate electrode of the third transistor M3 may be connected to a second scan line S2i. The third transistor M3 may be turned on when the second scan signal is supplied to the second scan line S2i, to electrically connect the second electrode of the first transistor M1 and the third node N3 to each other. That is, a timing at which the second electrode (e.g., a drain electrode) of the first transistor M1 and a gate electrode of the first transistor M1 are connected to each other may be controlled. When the third transistor M3 is turned on, the first transistor M1 may be diode-connected.

The fourth transistor M4 may be connected between the first node N1 and a second power line PL2 which provides the voltage of the first power source Vbs. The fourth transistor M4 may be turned on in response to the fourth scan signal supplied to a fourth scan line S4i, and supply the voltage of the first power source Vbs to the first node N1. A timing at which the voltage of the first power source Vbs is supplied to the first node N1 may be controlled by the fourth scan signal.

In an embodiment, the voltage of the first power source Vbs may be lower than the voltage of the first driving power source VDD and higher than the voltage of the second driving power source VSS.

Accordingly, when the fourth transistor M4 is turned on (e.g., when the fourth transistor M4 is in a turn-on state), a predetermined voltage may be applied to the first electrode (e.g., a source electrode) of the first transistor M1. When the third transistor M3 is in a turn-off state, the first transistor M1 may have an on-bias state (state in which the first transistor M1 can be turned on) (e.g., be on-biased).

The fifth transistor M5 may be connected between a first power line PL1 which provides the voltage of the first driving power source VDD and the first node N1. A gate electrode of the fifth transistor M5 may be connected to an ith emission control line Ei (hereinafter, referred to as an emission control line). The fifth transistor M5 may be turned off when the emission control signal is supplied to the emission control line Ei, and be turned on in other cases.

The sixth transistor M6 may be connected between the second electrode of the first transistor M1 (e.g., the second node N2) and the first electrode of the light emitting element LD (e.g., a fourth node N4). A gate electrode of the sixth transistor M6 may be connected to the emission control line Ei. The sixth transistor M6 may be controlled substantially identical to the fifth transistor M5.

The seventh transistor M7 may be connected between the third node N3 and a third power line PL3 which provides the voltage of the second power source Vint1 (hereinafter, referred to as a first initialization power source). A gate electrode of the seventh transistor M7 may be connected to a first scan line S1i.

The seventh transistor M7 may be turned on when the first scan signal is supplied to the first scan line S1i, to supply the voltage of the first initialization power source Vint1 to the third node N3. The voltage of the first initialization power source Vint1 may be set to a voltage lower than an optimum level of a data signal supplied to the data line Dj.

Accordingly, when the seventh transistor M7 is turned on (e.g., when the seventh transistor M7 is in a turn-on state), a gate voltage of the first transistor M1 may be initialized to the voltage of the first initialization power source Vint1.

The eighth transistor M8 may be connected between the first electrode of the light emitting element LD (e.g., the fourth node N4) and a fourth power line PL4 which provides the voltage of the third power source Vint2 (hereinafter, referred to as a second initialization power source). In an embodiment, a gate electrode of the eighth transistor M8 may be connected to the fourth scan line S4i.

The eighth transistor M8 may be turned on when the fourth scan signal is supplied to the fourth scan line S4i, to supply the voltage of the second initialization power source Vint2 to the first electrode of the light emitting element LD.

The ninth transistor M9 may be connected between the second electrode of the first transistor M1 (e.g., the second node N2) and the first electrode of the light emitting element LD (e.g., the fourth node N4). In an embodiment, a gate electrode of the ninth transistor M9 may be connected to a fifth scan line S5i.

The ninth transistor M9 may be turned on when the fifth scan signal is supplied to the fifth scan line S5i, to connect the second node N2 and the fourth node N4 to each other.

In low frequency driving in which the length of one frame period becomes long, when a voltage difference between the second node N2 and the fourth node N4 exists, a flicker phenomenon may be caused when the light emitting element LD emits light. Decreasing the voltage difference between the second node N2 and the fourth node N4 in low frequency driving of the display device may reduce or eliminate this flicker phenomenon.

Before the light emitting element LD emits light, the voltage difference between the second node N2 and the fourth node N4 may be decreased as the ninth transistor M9 is turned on. Accordingly, the flicker phenomenon due to the voltage difference between the second node N2 and the fourth node N4 can be prevented or reduced.

When the voltage of the second initialization power source Vint2 is supplied to the first electrode of the light emitting element LD, a parasitic capacitance of the light emitting element LD may be discharged. As a residual voltage charged in the parasitic capacitance is discharged (removed), unintended minute emission can be prevented or reduced. Thus, the black expression ability of the pixel PXij can be improved.

The first initialization power source Vint1 and the second initialization power source Vint2 may generate different voltages. That is, a voltage at which the third node N3 is initialized and a voltage at which the fourth node N4 is initialized may be set different from each other.

The first capacitor C1 may be connected between the first power line PL1 and the third node N3. The first capacitor C1 may store a voltage applied to the third node N3.

In an embodiment, the first transistor M1, the second transistor M2, the fourth transistor M4, the fifth transistor M5, the sixth transistor M6, and the eighth transistor M8 may be implemented with a poly-silicon semiconductor transistor. For example, the first transistor M1, the second transistor M2, the fourth transistor M4, the fifth transistor M5, the sixth transistor M6, and the eighth transistor M8 may include a poly-silicon semiconductor layer formed as an active layer (channel) through a low temperature poly-silicon (LTPS) process.

In addition, the first transistor M1, the second transistor M2, the fourth transistor M4, the fifth transistor M5, the sixth transistor M6, and the eighth transistor M8 may be implemented with a P-type transistor (e.g., a PMOS transistor). Accordingly, a gate-on voltage at which the first transistor M1, the second transistor M2, the fourth transistor M4, the fifth transistor M5, the sixth transistor M6, and the eighth transistor M8 are turned on may have a logic low level.

Due to its high response speed, the poly-silicon semiconductor transistor may be used in switching elements that perform fast switching.

The third transistor M3, the seventh transistor M7, and the ninth transistor M9 may be formed with an oxide semiconductor transistor. For example, the third transistor M3, the seventh transistor M7, and the ninth transistor M9 may be implemented with an N-type oxide semiconductor transistor (e.g., an NMOS transistor), and include an oxide semiconductor layer as an active layer. Accordingly, a gate-on voltage at which the third transistor M3, the seventh transistor M7, and the ninth transistor M9 are turned on may have a logic high level.

However, the present disclosure is not limited thereto, and the first to ninth transistors M1 to M9 may be formed with various types of transistors according to embodiments.

FIG. 4 is a timing diagram illustrating an example of signals supplied to the pixel PXij shown in FIG. 3. FIG. 5 is a timing diagram illustrating an example of signals supplied to the pixel PXij shown in FIG. 3 during one frame period.

Referring to FIGS. 3, 4, and 5, in variable frequency driving for controlling a frame frequency, one frame period FP may include a display scan period DSP and at least one bias scan period BSP.

The display scan period DSP may include a first non-emission period NEP1 and a first emission period EP1. The bias scan period BSP may include a second non-emission period NEP2 and a second emission period EP2. A non-emission period NEP and an emission period EP, which are shown in FIG. 4, may correspond to the first non-emission period NEP1 and the first emission period EP1, which are shown in FIG. 5, respectively.

The display scan period DSP may include a period in which a data signal actually corresponding to an output image is written. For example, when a still image is displayed by low frequency driving, the data signal may be written for each display scan period DSP.

As shown in FIG. 5, during the first non-emission period NEP1 as a non-emission period of the display scan period DSP, the first to fifth scan signals may be supplied to the pixel PXij. In an embodiment, the first scan signal may control a timing at which the voltage of the second power source Vint1 is supplied to the third node N3. The second scan signal may control a timing at which the second electrode (drain electrode) and the gate electrode of the first transistor M1 are connected (e.g., diode-connected). The third scan signal may control a timing at which a data signal is supplied to the first node N1. The fourth scan signal may control a timing at which the voltage of the first power source Vbs is supplied to the first node N1 and a timing at which the voltage of the third power source Vint2 is supplied to the fourth node N4. The fifth scan signal may control a timing at which the second and fourth nodes N2 and N4 are connected to each other.

In an embodiment, the one frame period FP may include only the display scan period DSP. That is, the bias scan period BSP may be omitted in the one frame period FP.

As shown in FIG. 5, the fourth scan signal may be supplied to the fourth scan line S4i in the second non-emission period NEP2 as a non-emission period of the bias scan period BSP. Therefore, the voltage of the first power source Vbs may be supplied to the source electrode of the first transistor M1 in the second non-emission period NEP2. Accordingly, a luminance change of the first transistor M1 in a frame period FP of low frequency driving can be minimized or reduced.

A period in which the emission control signal has a logic low level may be emission periods EP, EP1, and EP2, and periods except the emission periods EP, EP1, and EP2 may be non-emission periods NEP, NEP1, and NEP2.

A gate-on voltage of the second scan signal, the first scan signal, and the fifth scan signal, which are respectively supplied to the third transistor M3, the seventh transistor M7, and the ninth transistor M9, each of which is an N-type transistor, may be a logic high level. A gate-on voltage of the third scan signal and the fourth scan signal, which are supplied to the second transistor M2, the fourth transistor M4, and the eighth transistor M8, each of which is a P-type transistor, may have a logic low level.

Hereinafter, scan signals supplied in the display scan period DSP and an operation of the pixel PXij will be described in detail with reference to FIG. 4.

During the non-emission period NEP, the emission control signal may be supplied to the emission control line Ei. Accordingly, during the non-emission period NEP, the fifth transistor M5 and the sixth transistor M6 may be turned off. The non-emission period NEP may include first to fifth periods P1 to P5.

In the first period P1, the scan driver 200 may supply the first scan signal to the first scan line S1i. As the first scan signal is supplied, the seventh transistor M7 may be turned on, and the voltage of the first initialization power source Vint1 may be supplied to the third node N3. Therefore, a gate voltage of the first transistor M1 may be initialized to the voltage of the first initialization power source Vint1.

In the second period P2, the scan driver 200 may supply the second scan signal to the second scan line S2i. As the second scan signal is supplied, the third transistor M3 may be turned on. The first transistor M1 may be diode-connected when the third transistor M3 is turned on (e.g., when the third transistor M3 is in the turn-on state), and the magnitude of a gate-source voltage of the first transistor M1 may be decreased to a level corresponding to an absolute value of a threshold voltage of the first transistor M1.

In the third period P3, the scan driver 200 may supply the second scan signal to the second scan line S2i, and supply the third scan signal to the third scan line S3i. Accordingly, the second transistor M2 and the third transistor M3 may be turned on. Therefore, since a data signal supplied to the data line Dj is supplied to the first node N1, and the first transistor M1 is diode-connected, data writing and threshold voltage compensation of the first transistor M1 may be performed.

In the fourth period P4, the scan driver 200 may supply the fourth scan signal to the fourth scan line S4i. As the fourth scan signal is supplied, the fourth transistor M4 and the eighth transistor M8 may be turned on.

When the fourth transistor M4 is turned on (e.g., when the fourth transistor M4 is in the turn-on state), the voltage of the first power source Vbs may be supplied to the first node N1. When the eighth transistor M8 is turned on (e.g., when the eighth transistor M8 is in the turn-on state), the voltage of the third power source Vint2 may be supplied to the fourth node N4.

A voltage difference between a gate voltage and a source voltage of the first transistor M1 may be considerably decreased by the threshold voltage compensation in the third period P3. Then, a characteristic of the first transistor M1 may be changed again, and a driving current of the emission period EP may increase or excitation of a black grayscale may be viewed.

In order to prevent such a characteristic change, the fourth transistor M4 may be turned on in the fourth period P4. Thus, in the fourth period P4, the voltage of the first power source Vbs is supplied to the source electrode of the first transistor M1, so that the first transistor M1 can be set to be in an on-bias state.

In the fifth period P5, the scan driver 200 may supply the fifth scan signal to the fifth scan line S5i. As the fifth scan signal is supplied, the ninth transistor M9 may be turned on. Thus, the second node N2 and the fourth node N4 are connected to each other, so that the voltage difference between the second node N2 and the fourth node N4 can be decreased.

In an embodiment, the ninth transistor M9 may be turned on after the period P4 in which the voltage of the third power source Vint2 is lastly applied to the fourth node N4 before the emission period EP.

Subsequently, the emission driver 300 may suspend the supply of the emission control signal to the emission control line Ei in the emission period EP. Accordingly, the fifth and sixth transistors M5 and M6 may be turned on, and a driving current based on the data signal may be supplied to the light emitting element LD through the first transistor M1. The light emitting element LD may emit light with a luminance corresponding to the driving current.

As described above, before the emission period EP, the ninth transistor M9 is turned on, the voltage difference between the second node N2 and the fourth node N4 can be decreased. Accordingly, the flicker phenomenon which may occur in the emission period EP can be prevented or reduced.

Although the first to fifth scan signals supplied to the first to fifth periods P1 to P5 have been described with reference to FIG. 5, the preset disclosure is not limited thereto. For example, in some embodiments, a pulse width of each of the first to fifth scan signals may be changed. Also, it has been described that the first to fifth scan signals are sequentially supplied. However, the present disclosure is not limited thereto. For example, in some embodiments, the order in which the first to fifth scan signals are supplied in the non-emission period NEP may be changed.

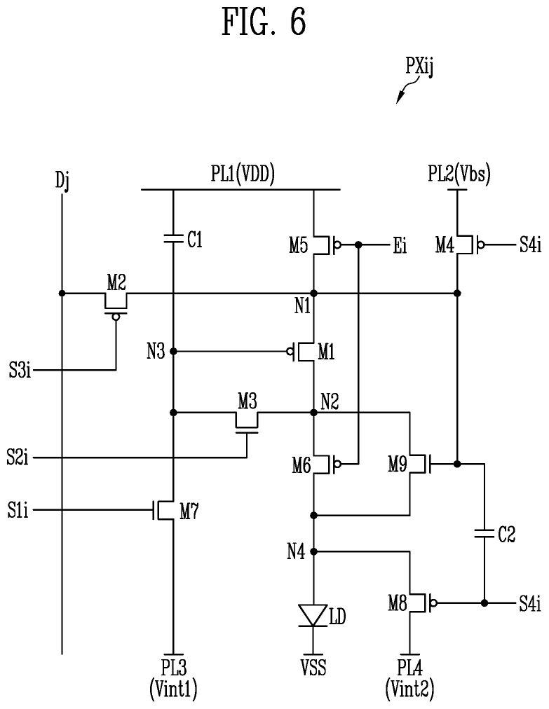

FIG. 6 is a circuit diagram illustrating an example of the pixel PX included in the display device shown in FIG. 1.

Referring to FIG. 6, a ninth transistor M9 may be turned on based on the fourth scan signal.

In FIG. 6, for convenience of description, a pixel PXij which is located on an ith horizontal line (or ith pixel row) and is connected to a jth data line Dj will be illustrated (i and j are positive integers).

The pixel PXij may include a light emitting element LD, first to ninth transistors M1 to M9, a first capacitor C1, and a second capacitor C2. The light emitting element LD, the first to ninth transistors M1 to M9, and the first capacitor C1, which are shown in FIG. 6, are similar to the light emitting element LD, the first to ninth transistors M1 to M9, and the first capacitor C1, which are shown in FIG. 3, and therefore, for convenience of explanation, a further description of these components and related technical aspects will be omitted.

The ninth transistor M9 may be connected between a second electrode of the first transistor M1 (e.g., a second node N2) and a first electrode of the light emitting element LD (e.g., a fourth node N4). In an embodiment, a gate electrode of the ninth transistor M9 may be connected to a first node N1.

The second capacitor C2 may be connected between the first node N1 and a fourth scan line S4i. Accordingly, the fourth scan signal may be supplied to the gate electrode of the ninth transistor M9 through the fourth scan line S4i and the second capacitor C2.

Referring to FIG. 4, during the fourth period P4, the eighth transistor M8 may be turned on and the ninth transistor M9 may be turned off, based on the fourth scan signal provided to the fourth scan line S4i.

That is, before the emission period EP, as the ninth transistor M9 is turned on, a voltage difference between the second node N2 and the fourth node N4 can be decreased. Accordingly, a flicker phenomenon due to the voltage difference between the second node N2 and the fourth node N4 can be prevented or reduced.

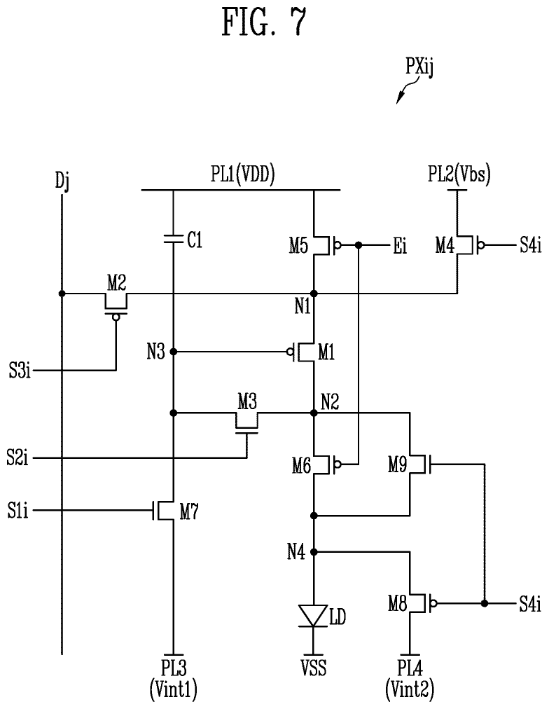

FIG. 7 is a circuit diagram illustrating an example of the pixel PX included in the display device shown in FIG. 1.

Referring to FIG. 7, a ninth transistor M9 may be turned on based on the fourth scan signal.

In FIG. 7, for convenience of description, a pixel PXij which is located on an ith horizontal line (or ith pixel row) and is connected to a jth data line Dj will be illustrated (i and j are positive integers).

The pixel PXij may include a light emitting element LD, first to ninth transistors M1 to M9, and a first capacitor C1. The light emitting element LD, the first to ninth transistors M1 to M9, and the first capacitor C1, which are shown in FIG. 7, are similar to the light emitting element LD, the first to ninth transistors M1 to M9, and the first capacitor C1, which are shown in FIG. 3, and therefore, for convenience of explanation, a further description of these components and related technical aspects will be omitted.

The ninth transistor M9 may be connected between a second electrode of the first transistor M1 (e.g., a second node N2) and a first electrode of the light emitting element LD (e.g., a fourth node N4). In an embodiment, a gate electrode of the ninth transistor M9 may be connected to a fourth scan line S4i.

Referring to FIG. 4, during the fourth period P4, the eighth transistor M8 may be turned on and the ninth transistor M9 may be turned off, based on the fourth scan signal provided to the fourth scan line S4i. During the fifth period P5, the eighth transistor M8 may be turned off and the ninth transistor M9 may be turned on, based on the fourth scan signal provided to the fourth scan line S4i.

That is, before the emission period EP, as the ninth transistor M9 is turned on, a voltage difference between the second node N2 and the fourth node N4 can be decreased. Accordingly, a flicker phenomenon due to the voltage difference between the second node N2 and the fourth node N4 can be prevented or reduced.

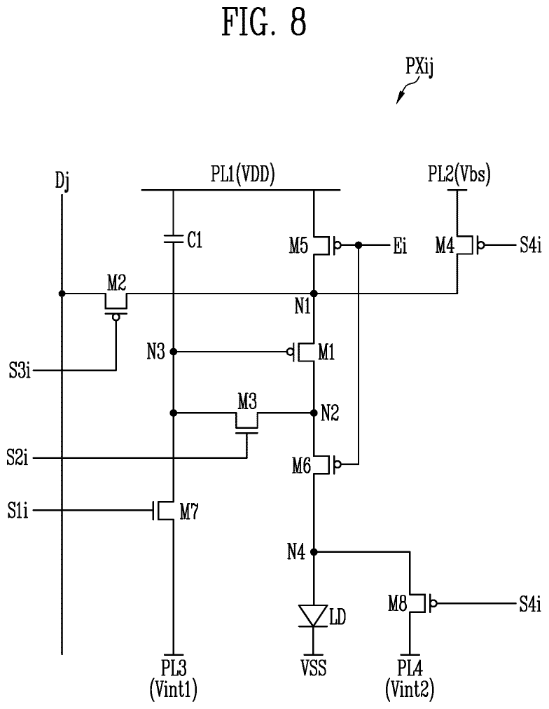

FIG. 8 is a circuit diagram illustrating an example of the pixel PX included in the display device shown in FIG. 1.

Referring to FIG. 8, a pixel PXij may include a light emitting element LD, first to eighth transistors M1 to M8, and a first capacitor C1.

In FIG. 8, for convenience of description, the pixel PXij which is located on an ith horizontal line (or ith pixel row) and is connected to a jth data line Dj will be illustrated (i and j are positive integers).

The light emitting element LD, the first to eighth transistors M1 to M8, and the first capacitor C1, which are shown in FIG. 8, are similar to the light emitting element LD, the first to eighth transistors M1 to M8, and the first capacitor C1, which are shown in FIG. 3, and therefore, for convenience of explanation, a further description of these components and related technical aspects will be omitted.

The voltage of the third power source Vint2 may be a voltage including a plurality of pulses. In an embodiment, the voltage of the third power source Vint2 may be a voltage including step pulses, each of which increases by a constant step voltage.

Accordingly, a voltage of a fourth node N4 to which the fourth scan signal is provided may increase based on the voltage of the third power source Vint2. That is, since the voltage of the fourth node N4 increases to be similar to a voltage of a second node N2, a voltage difference between the second node N2 and the fourth node N4 can be decreased. Accordingly, a flicker phenomenon due to the voltage difference between the second node N2 and the fourth node N4 can be prevented or reduced.

In the display device according to embodiments of the present disclosure, a voltage difference between one electrode of a driving transistor and one electrode of a light emitting element is decreased before an emission period. As a result, a flicker phenomenon can be prevented or reduced.

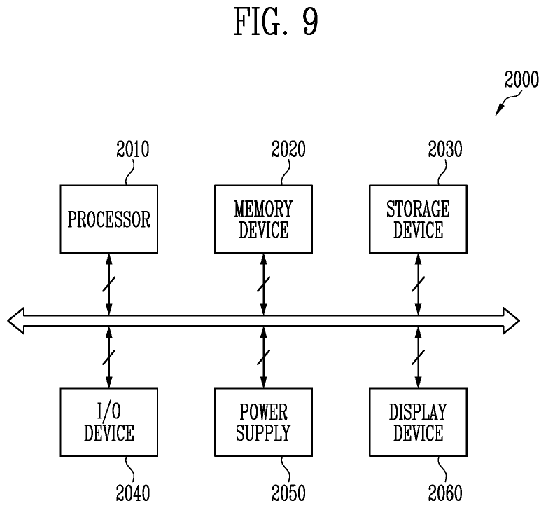

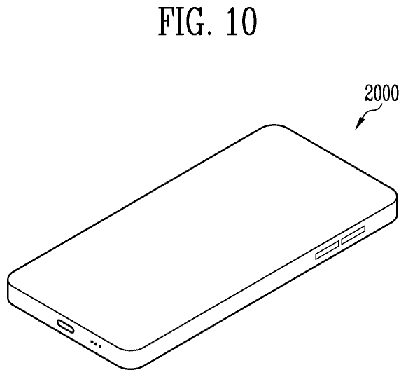

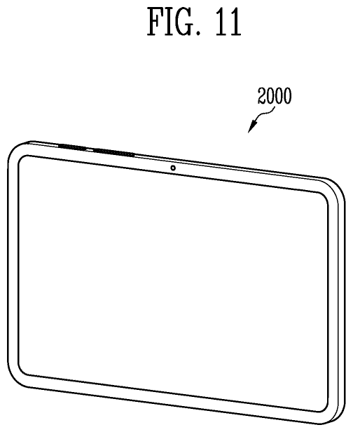

FIG. 9 is a block diagram illustrating an electronic device 2000 in accordance with embodiments of the present disclosure. FIG. 10 is a diagram illustrating an example where the electronic device 2000 of FIG. 9 is a smartphone. FIG. 11 is a schematic diagram illustrating an example where the electronic device 2000 of FIG. 9 is a tablet computer.

Referring to FIGS. 9 to 11, the electronic device 2000 may include a processor 2010, a memory device 2020, a storage device 2030, an input/output (I/O) device 2040, a power supply 2050, and a display device 2060. The display device 2060 may be the display device of FIG. 1. The electronic device 2000 may further include various ports for communication with a video card, a sound card, a memory card, a USB device, or other systems. In an embodiment, as illustrated in FIG. 10, the electronic device 2000 may be implemented as a smartphone. In an embodiment, as illustrated in FIG. 11, the electronic device 2000 may be implemented as a table computer. However, the aforementioned examples are illustrative, and the electronic device 2000 is not limited to the aforementioned examples. For example, the electronic device 2000 may be implemented as a cellular phone, a video phone, a smart pad, a smartwatch, a navigation device for vehicles, a computer monitor, a laptop computer, a head-mounted display device, and so on.

The processor 2010 may perform specific calculations or tasks. In an embodiment, the processor 2010 may include at least one of a central processing unit, an application processor, a graphic processing unit, a communication processor, an image signal processor, a controller, or the like. The processor 2010 may be connected to other components through an address bus, a control bus, a data bus, and the like. In an embodiment, the processor 2010 may be connected to an expansion bus such as a peripheral component interconnect (PCI) bus. In an embodiment, the processor 2010 may provide input image data to the display device 2060. Hence, the display device 2060 may display an image based on the input image data provided from the processor 2010.

The memory device 2020 may store data needed to perform the operation of the electronic device 2000. The memory device 2020 may function as a working memory and/or a buffer memory for the processor 2010. For example, the memory device 2020 may include one or more volatile memory devices such as a dynamic random access memory (DRAM) device, a static random access memory (SRAM) device, and a mobile DRAM device.

The storage device 2030 may store data in response to control signals or data from the processor 2010. The storage device 2030 may include one or more non-volatile storages to retain the data even when the electronic device 2000 is powered off. In some embodiments, the storage device 2030 may include a solid state drive (SSD), a hard disk drive (HDD), a CD-ROM, or the like.

The I/O device 2040 may include input devices such as a keyboard, a keypad, a touchpad, a touch screen, and a mouse, and output devices such as a speaker and a printer. In an embodiment, the display device 2060 may be integrated with the I/O device 2040.

The power supply 2050 may supply power needed to perform the operation of the electronic device 2000. For example, the power supply 2050 may include a power management integrated circuit (PMIC). In an embodiment, the power supply 2050 may supply power to the display device 2060.

The display device 2060 may display images in response to image data signals and/or control signals from the processor 2010. The display device 2060 may be connected to other components through the buses or other communication links.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A display device, comprising:
a pixel including a light emitting element and a first transistor connected between a first node and a second node,
wherein the first transistor is configured to generate a driving current,
wherein the pixel is connected to a first scan line, a second scan line, a third scan line, a fourth scan line, a fifth scan line, an emission control line, and a data line;
an emission driver configured to supply an emission control signal to the emission control line;
a scan driver configured to supply first to fifth scan signals respectively to the first to fifth scan lines in a period in which the emission control signal is supplied; and
a data driver configured to supply a data signal to the data line,
wherein the first scan signal controls a timing at which the second node and a first electrode of the light emitting element are connected to each other.

2. The display device of claim 1, wherein the pixel further includes:
a second transistor connected between the data line and the first node,
wherein the second transistor is turned on in response to the second scan signal;
a third transistor connected between the second node and a third node to which a gate electrode of the first transistor is connected,
wherein the third transistor is turned on in response to the third scan signal;
a fourth transistor connected between the first node and a first power line that provides a voltage of a first power source,
wherein the fourth transistor is turned on in response to the fourth scan signal;
a fifth transistor connected between a second power line that provides a driving power source and the first node,
wherein the fifth transistor is turned off in response to the emission control signal;
a sixth transistor connected between the second node and the first electrode of the light emitting element,
wherein the sixth transistor is turned off in response to the emission control signal supplied to the emission control line; and
a seventh transistor connected between the second node and the first electrode of the light emitting element,
wherein the seventh transistor is turned on in response to the first scan signal.

3. The display device of claim 2, wherein, after the scan driver supplies the fourth scan signal to the fourth scan line, the scan driver supplies the first scan signal to the first scan line.

4. The display device of claim 2, wherein the pixel further includes:
an eighth transistor connected between the third node and a third power line that provides a voltage of a second power source,
wherein the eighth transistor is turned on in response to the fifth scan signal.

5. The display device of claim 4, wherein the pixel further includes:
a ninth transistor connected between the first electrode of the light emitting element and a fourth power line that provides a voltage of a third power source,
wherein the ninth transistor is turned on in response to the fourth scan signal.

6. The display device of claim 5, wherein one frame period includes a plurality of non-emission periods divided by the emission control signal,
wherein the scan driver supplies the fourth scan signal in the non-emission periods, and
wherein the scan driver supplies the first scan signal, the second scan signal, the third scan signal, and the fifth scan signal in only a first non-emission period among the non-emission periods.

7. The display device of claim 6, wherein the first non-emission period includes a first period and a second period subsequent to the first period, and
wherein the scan driver is further configured to:
supply the fourth scan signal to the fourth scan line in the first period; and
supply the first scan signal to the first scan line in the second period.

8. The display device of claim 7, wherein the first non-emission period further includes a third period subsequent to the second period, a fourth period subsequent to the third period, and a fifth period subsequent to the fourth period,
wherein the scan driver is further configured to:
supply the fifth scan signal to the fifth scan line in the third period;
supply the third scan signal to the third scan line in the fourth period; and
supply the second scan signal to the second scan line and supply the third scan signal to the third scan line in the fifth period, and
wherein a time at which the fifth period is ended is earlier than a time at which the first period is started.

9. A display device, comprising:
a pixel including a light emitting element and a first transistor connected between a first node and a second node,
wherein the first transistor is configured to generate a driving current,
wherein the pixel is connected to a first scan line, a second scan line, a third scan line, a fourth scan line, an emission control line, and a data line;
an emission driver configured to supply an emission control signal to the emission control line;
a scan driver configured to supply first to fourth scan signals respectively to the first to fourth scan lines in a period in which the emission control signal is supplied; and
a data driver configured to supply a data signal to the data line,
wherein the first scan signal controls a timing at which the second node and a first electrode of the light emitting element are connected to each other.

10. The display device of claim 9, wherein the pixel further includes:
a second transistor connected between the data line and the first node,
wherein the second transistor is turned on in response to the second scan signal;
a third transistor connected between the second node and a third node to which a gate electrode of the first transistor is connected,
wherein the third transistor is turned on in response to the third scan signal;
a fourth transistor connected between the first node and a first power line that provides a voltage of a first power source,
wherein the fourth transistor is turned on in response to the first scan signal;
a fifth transistor connected between a second power line that provides a driving power source and the first node,
wherein the fifth transistor is turned off in response to the emission control signal;
a sixth transistor connected between the second node and the first electrode of the light emitting element,
wherein the sixth transistor is turned off in response to the emission control signal supplied to the emission control line; and
a seventh transistor connected between the second node and the first electrode of the light emitting element,
wherein the seventh transistor includes a gate electrode connected to the first node.

11. The display device of claim 10, wherein the pixel further includes:
an eighth transistor connected between the first electrode of the light emitting element and a third power line that provides a voltage of a second power source,
wherein the eighth transistor is turned on in response to the first scan signal.

12. The display device of claim 11, wherein the pixel further includes:
a capacitor connected between the first node and a gate electrode of the eighth transistor.

13. The display device of claim 12, wherein the pixel further includes:
a ninth transistor connected between the third node and a fourth power line that provides a voltage of a third power source,
wherein the ninth transistor is turned on in response to the fourth scan signal.

14. The display device of claim 13, wherein one frame period includes a plurality of non-emission periods divided by the emission control signal,
wherein the scan driver supplies the first scan signal in the non-emission periods, and
wherein the scan driver supplies the second scan signal, the third scan signal, and the fourth scan signal in only a first non-emission period among the non-emission periods.

15. The display device of claim 9, wherein the pixel further includes:
a second transistor connected between the data line and the first node,
wherein the second transistor is turned on in response to the second scan signal;
a third transistor connected between the second node and a third node connected to the gate electrode of the first transistor,
wherein the third transistor is turned on in response to the third scan signal;
a fourth transistor connected between the first node and a first power line that provides a voltage of a first power source,
wherein the fourth transistor is turned on in response to the first scan signal;
a fifth transistor connected between a second power line that provides a driving power source and the first node,
wherein the fifth transistor is turned off in response to the emission control signal;
a sixth transistor connected between the second node and the first electrode of the light emitting element,
wherein the sixth transistor is turned off in response to the emission control signal;
a seventh transistor connected between the first electrode of the light emitting element and a third power line that provides a voltage of a second power source,
wherein the seventh transistor is turned on in response to the first scan signal; and
an eighth transistor connected between the second node and the first electrode of the light emitting element,
wherein the eighth transistor includes a gate electrode connected to a gate electrode of the seventh transistor.

16. The display device of claim 15, wherein the pixel further includes:
a ninth transistor connected between the third node and a fourth power line that provides a voltage of a third power source,
wherein the ninth transistor is turned on in response to the fourth scan signal.

17. A display device, comprising:
a pixel including a light emitting element and a first transistor connected between a first node and a second node,
wherein the first transistor is configured to generate a driving current,
wherein the pixel is connected to a first scan line, a second scan line, a third scan line, a fourth scan line, an emission control line, and a data line;
an emission driver configured to supply and suspend an emission control signal to the emission control line;
a scan driver configured to supply first to fourth scan signals respectively to the first to fourth scan lines in a period in which the emission control signal is supplied; and
a data driver configured to supply a data signal to the data line,
wherein a voltage including a plurality of pulses is provided to a first electrode of the light emitting element before the supply of the emission control signal is suspended.

18. The display device of claim 17, wherein the pixel further includes:
a second transistor connected between the data line and the first node,
wherein the second transistor is turned on in response to the first scan signal;
a third transistor connected between the second node and a third node to which a gate electrode of the first transistor is connected,
wherein the third transistor is turned on in response to the second scan signal;
a fourth transistor connected between the first node and a first power line that provides a voltage of a first power source,
wherein the fourth transistor is turned on in response to the third scan signal;
a fifth transistor connected between a second power line that provides a driving power source and the first node,
wherein the fifth transistor is turned off in response to the emission control signal;
a sixth transistor connected between the second node and the first electrode of the light emitting element,
wherein the sixth transistor is turned off in response to the emission control signal supplied to the emission control line; and
a seventh transistor connected between the first electrode of the light emitting element and a third power line that provides a voltage of a second power source,
wherein the seventh transistor is turned on in response to the third scan signal.

19. The display device of claim 18, wherein the pixel further includes:
an eighth transistor connected between the third node and a fourth power line that provides a voltage of a third power source,
wherein the eighth transistor is turned on in response to the fourth scan signal.

20. The display device of claim 18, wherein the voltage of the second power source includes the plurality of pulses.

21. An electronic device, comprising:
a processor to provide input image data; and
a display device to display an image based on the input image data,
wherein the display device, comprising:
a pixel including a light emitting element and a first transistor connected between a first node and a second node,
wherein the first transistor is configured to generate a driving current,
wherein the pixel is connected to a first scan line, a second scan line, a third scan line, a fourth scan line, a fifth scan line, an emission control line, and a data line;
an emission driver configured to supply an emission control signal to the emission control line;
a scan driver configured to supply first to fifth scan signals respectively to the first to fifth scan lines in a period in which the emission control signal is supplied; and
a data driver configured to supply a data signal to the data line,
wherein the first scan signal controls a timing at which the second node and a first electrode of the light emitting element are connected to each other.
